(19) United States
(12) Patent Application Publication
(10) Pub. No.: US 2013/0033812 A1
(43) Pub. Date: Feb. 7, 2013

(54) DUMMY HARD DISK DRIVE

(71) Applicant: ZHENG-HENG SUN, Tu-Cheng (TW)

(72) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/282,477

(22) Filed: Oct. 27, 2011

(30) Foreign Application Priority Data
Aug. 5, 2011 (CN) 201110223525.8

(51) Int. Cl. G06F 1/16; B32B 7/04

(52) U.S. Cl. 361/679.33; 428/12

(57) ABSTRACT

A dummy hard disk drive (HDD) includes a bottom plate, two first side plates pivotably connected to two opposite sides of the bottom plate, and two second side plates pivotably connected to two opposite ends of the bottom plate. The first side plates and the second side plates are operable to rotate relative to the bottom plate, until the first side plates and the second side plates are substantially perpendicular to the bottom plate to form a rectangular frame. The first side plates and the second side plate are operable to rotate relative to the bottom plate, until the first side plates and the second side plate are substantially coplanar with the bottom plate so as to form a flat plate.

### CROSS-REFERENCE TO RELATED APPLICATIONS

Relevant subject matter is disclosed in two pending U.S. patent applications, with serial application Nos. 13/221,857 (Docket No. US40789) and 13/280,353 (Docket No. US41133), respectively, filed on Aug. 30, 2011 and Oct. 25, 2011, and both entitled “DUMMY HARD DISK DRIVE”, which are assigned to the same assignee with this patent application.

### BACKGROUND

1. Technical Field

The present disclosure relates to a dummy hard disk drive (HDD) for an electronic device.

2. Description of Related Art

An electronic device, such as a computer or a server, usually includes a plurality of brackets for mounting HDDs. A dummy HDD may be fitted in each bracket to avoid the bracket from being deformed or damaged when manufacturing or transporting these brackets. When a real HDD is received in the bracket, the dummy HDD will be taken out. However, a traditional dummy HDD is often a fixed structure, and not foldable, which causes a waste of space when the dummy HDD is boxed and transported.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an embodiment of a dummy hard disk drive (HDD).

FIG. 2 is an exploded, isometric view of the dummy HDD of FIG. 1.

FIG. 3 is an inverted view of FIG. 2.

FIG. 4 is an enlarged view of the circled portion IV of FIG. 2.

FIG. 5 is an enlarged view of the circled portion V of FIG. 2.

FIG. 6 is an isometric view showing the dummy HDD mounted to a HDD bracket.

FIG. 7 is an isometric view showing a different state of use of the dummy HDD of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

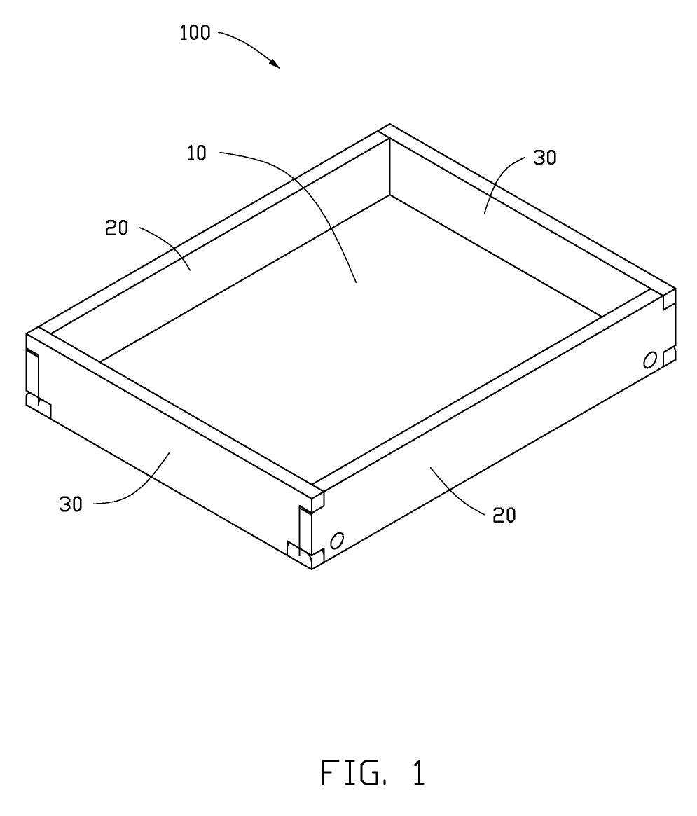

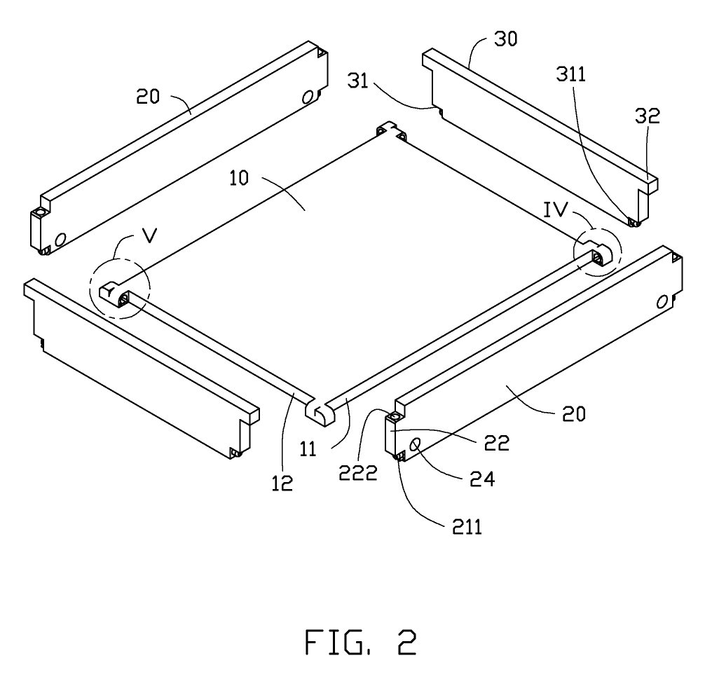

Referring to FIGS. 1 and 2, an embodiment of a dummy hard disk drive (HDD) 100 includes a substantially rectangular bottom plate 10, two side plates 20 pivotably mounted to two opposite sides 11 of the bottom plate 10, and two end plates 30 pivotably mounted to two opposite ends 12 of the bottom plate 10. The bottom plate 10, the first side plates 20, and the second side plates 30 are made of resilient material, such as rubber or plastic.

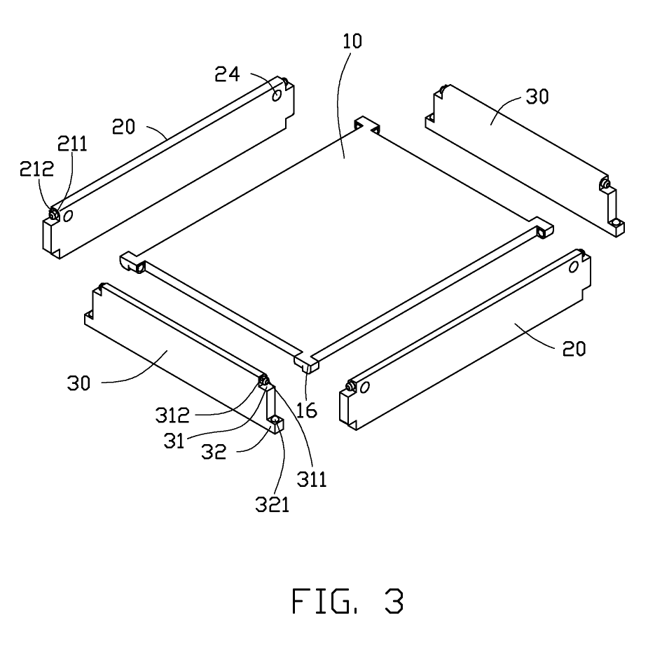

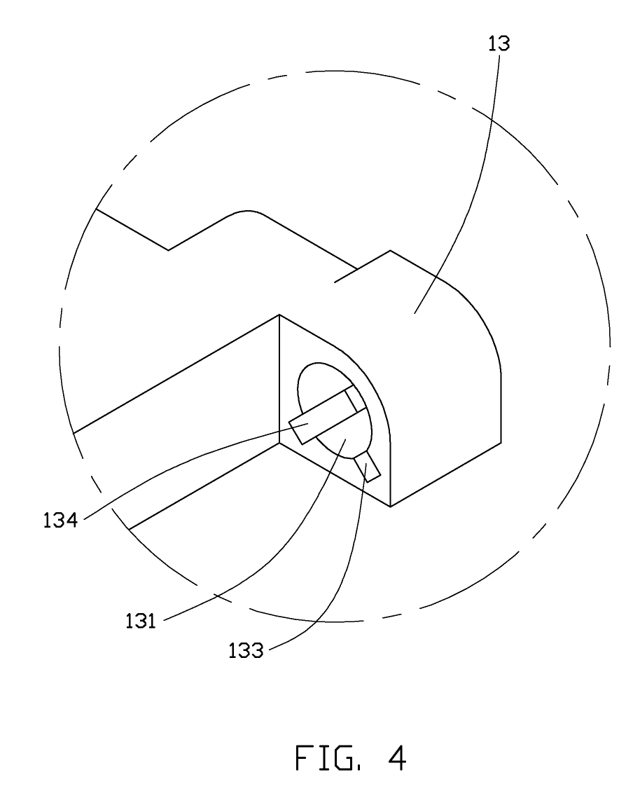

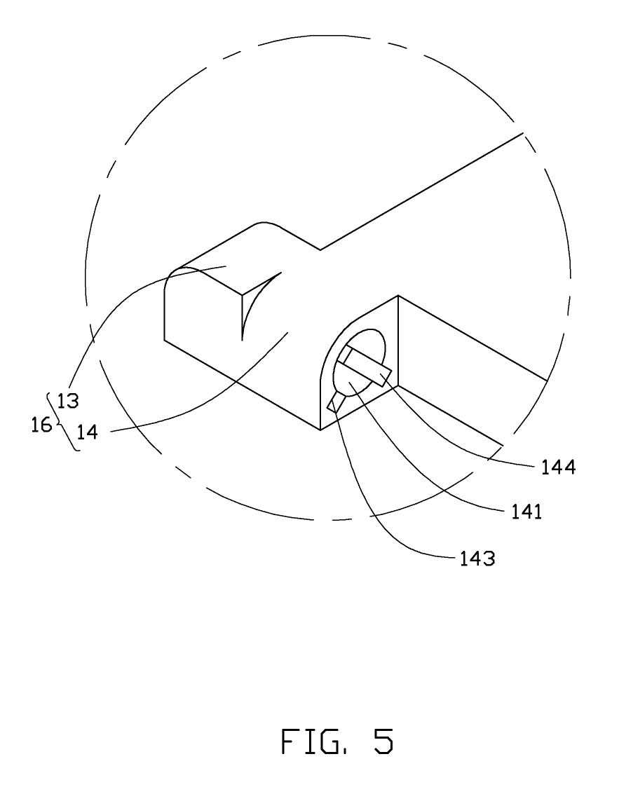

Referring to FIG. 3 to FIG. 5, the bottom plate 10 includes four first connecting portions 13 and four second connecting portions 14 formed at the four corners of the bottom plate 10. Two of the first connecting portions 13 are located at one of the sides 11, and the other two of the first connecting portions 13 are located at the other side 11. Two of the second connecting portions 14 are located at one of the ends 12, and the other two of the second connecting portions 14 are located at the other end 12. A first pivot hole 131 is defined in each first connecting portion 13, facing the other first connecting portion 13 at the same side 11. A first positioning slot 133 and a second positioning slot 134 are defined in the inner surface bounding the first pivot hole 131 of one of the first connecting portions 13 at the same side 11. The first positioning slot 133 is angled about 90 degrees from the second positioning slot 134. A second pivot hole 141 is defined in each second connecting portion 14, facing the other second connecting portion 14 at the same end 12. A first positioning slot 143 and a second positioning slot 144 are defined in the inner surface bounding the second pivot hole 141 of one of the second connecting portions 14 at the same end 12. The first positioning slot 143 is angled about 90 degrees from the second positioning slot 144. In this embodiment, the first connecting portion 13 and the second connecting portion 14 at each corner are connected together to form a protrusion 16.

Each first side plate 20 is substantially a bar, and includes two projections 22 extending from opposite ends of the first side plate 20. A first pin 211 extends from each end of the first side plate 20, near the corresponding projection 22. The first pin 211 of at one of the ends of the first side plate 20 forms a flexible raised portion 212 on the circumference of the first pin 211, for engagement either in the first positioning slot 133 or in the second positioning slot 134 of a corresponding first connecting portion 13, thereby preventing any rotation of the first side plate 20. A positioning hole 222 is defined in the top of each projection 22. Two mounting holes 24 are defined in the ends of the first side plate 20, adjacent to the bottom side of each of the first side plates 20.

Each second side plate 30 includes two recesses 31 defined in opposite ends of the second side plate 30, and two projections 32 extending from opposite ends of the second side plate 30. Two second pins 311 extend from the middle of each recess 31.

One of the second pins 311 forms a flexible raised portion 312 on the circumference of one of the first pins 311, for engagement in either the first positioning slot 143 or the second positioning slot 144, to prevent twisting of the second side plate 30. A positioning protrusion 321 protrudes from an undersurface of each projection 32, facing the corresponding recess 31.

Referring to FIG. 1, in assembly, each first side plate 20 is attached to a corresponding side 11. The first pins 211 are pivotably inserted into the corresponding first pivot holes 131. Each second side plate 30 is attached to a corresponding end 12. The second pins 311 are pivotably inserted into the corresponding second pivot holes 141. The first side plates 20 and the second side plates 30 are rotated relative to the bottom plate 10, until the first side plates 20 and the second side plates 30 are perpendicular to the bottom plate 10, to form a rectangular frame. The size and shape of the frame match those of an actual HDD, thereby forming the dummy HDD 100. The raised portions 212 are engaged in the corresponding first positioning slots 133, to position the first side plates 20 perpendicular to the bottom plate 10. The raised portions 312 are engaged in the corresponding first positioning slots 143, to position the second side plates 30 perpendicular to the bottom plate 10. The projections 32 are located above the corresponding projections 22. The positioning protrusions 321 are engaged in the corresponding positioning holes 222.

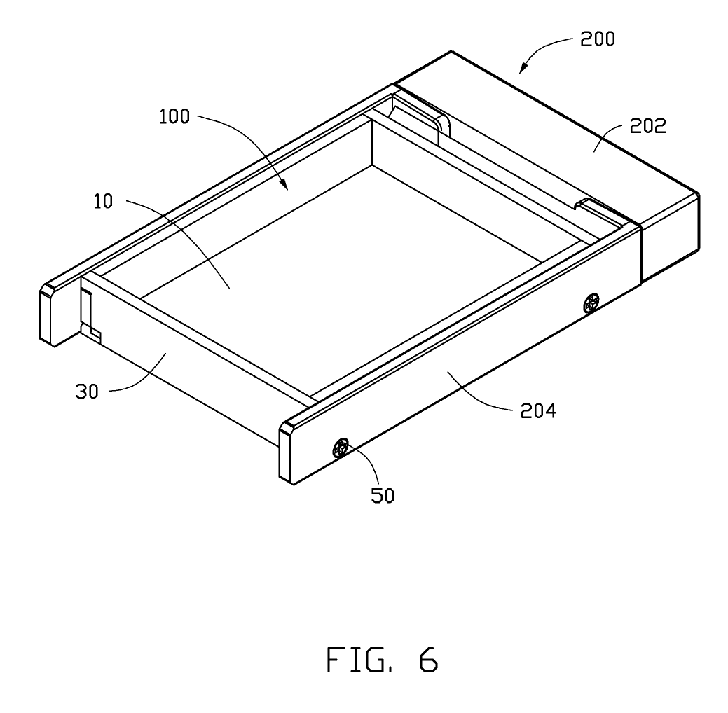

Referring to FIG. 6, the dummy HDD 100 is mountable in an HDD bracket 200. The HDD bracket 200 includes a base 202 and two parallel mounting plates 204 extending from opposite ends of the base 202. The dummy HDD 100 is mounted between the mounting plates 204 by means of screws 50 extending through the mounting plates 204 to screw into the mounting holes 24.

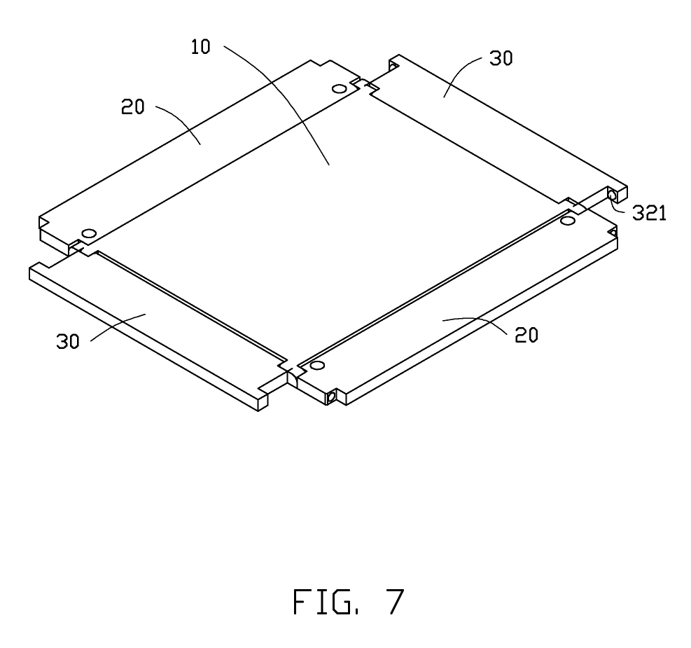

Referring to FIG. 7, when the dummy HDD 100 is not being used, the positioning protrusions 321 are disengaged from the corresponding positioning holes 222. The first side plates 20 and the second side plates 30 are rotated relative to the bottom plate 10, until the first side plates 20 and the second side plate 30 are substantially coplanar with the bottom plate 10. The raised portions 212 are engaged in the corresponding second positioning slots 134, to position the first side plates 20 so as to be coplanar with the bottom plate 10. The raised portions 312 are engaged in the corresponding second positioning slots 144, to position the second side plates 30 so as to be coplanar with the bottom plate 10. Therefore, the dummy HDD 100 is transformed into a simple flat plate, to occupy the minimum of space.

In this embodiment, the bottom plate 10, the first side plates 20, and the second side plates 30 are pivotably connected to form the dummy HDD 100. When the dummy HDD 100 is needed in the HDD bracket 200, the dummy HDD 100 can be transformed into a rectangular frame. When not in use, the dummy HDD 100 can be spread out flat for easy packing and transporting.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A dummy hard disk drive (HDD), comprising:
a bottom plate;
two first side plates pivotably mounted to two opposite sides of the bottom plate; and
two second side plates pivotably mounted to two opposite ends of the bottom plate;
wherein the first side plates and the second side plates are operable to rotate relative to the bottom plate until the first side plates and the second side plates are substantially perpendicular to the bottom plate to form a hollow rectangular frame; and the first side plates and the second side plate are operable to rotate relative to the bottom plate until the first side plates and the second side plate are substantially coplanar with the bottom plate.

2. The dummy HDD of claim 1, wherein the bottom plate, the first side plates, and the second side plates are made of resilient material.

3. The dummy HDD of claim 1, wherein the bottom plate is substantially rectangular, and comprises four first connecting portions formed at four corners of the bottom plate and four second connecting portions formed at the four corners, each first side plate is pivotably connected between the first connecting portions at a same one of the two opposite sides of the bottom plate, each second side plate is pivotably connected between the second connecting portions at a same one of the two opposite ends of the bottom plate.

4. The dummy HDD of claim 3, wherein a first pivot hole is defined in each first connecting portion, each first side plate comprises two projections extending from opposite ends of the first side plate, two first pins extend from the ends of the first side plate below the corresponding projections, the first pins are pivotably engaged in the corresponding first pivot holes.

5. The dummy HDD of claim 4, wherein a first positioning slot and a second positioning slot are defined in an inner surface bounding one of the first pivot holes of each side of the bottom plate, one of the first pins of each first side plate forms an elastic raised portion on the circumference of the one of the first pins, for engagement in either the first positioning slot to position the first side plate substantially perpendicular to the bottom plate or the second positioning slot to position the first side plate substantially coplanar with the bottom plate.

6. The dummy HDD of claim 3, wherein a second pivot hole is defined in each second connecting portion, each second side plate comprises two projections extending from opposite ends of the second side plate, two second pins extend from the ends of the second side plate below the corresponding projections, the second pins are pivotably engaged in the corresponding second pivot holes.

7. The dummy HDD of claim 6, wherein a first positioning slot and a second positioning slot are defined in an inner surface bounding one of the second pivot holes of each end of the bottom plate, one of the second pins of each second side plate forms an elastic raised portion on the circumference of the one of the second pins, for engagement in either the first positioning slot to position the second side plate substantially perpendicular to the bottom plate or the second positioning slot to position the second side plate substantially coplanar with the bottom plate.

8. An electronic device comprising:
a base;
two parallel sidewalls extending from the base; and
a dummy hard disk drive mounted between the sidewalls, and comprising a bottom plate, two first side plates pivotably mounted to two opposite sides of the bottom plate, and two second side plates pivotably mounted to two opposite ends of the bottom plate;
wherein the first side plates and the second side plates are operable to rotate to be substantially perpendicular to the bottom plate to form a hollow rectangular frame.

9. The electronic device of claim 8, wherein the bottom plate, the first side plates, and the second side plates are made of resilient material.

10. The electronic device of claim 8, wherein the bottom plate is substantially rectangular, and comprises four first connecting portions formed at four corners of the bottom plate and four second connecting portions formed at the four corners, each first side plate is pivotably connected between the first connecting portions at a same one of the two opposite sides of the bottom plate, each second side plate is pivotably connected between the second connecting portions at a same one of the two opposite ends of the bottom plate.

11. The electronic device of claim 10, wherein a first pivot hole is defined each first connecting portion, each first side plate comprises two projections extending from opposite ends of the first side plate, two first pins extend from the ends of the first side plate below the corresponding projections, the first pins are pivotably engaged in the corresponding first pivot holes.

12. The electronic device of claim 11, wherein a positioning slot is defined in an inner surface bounding one of the first pivot holes of each side of the bottom plate, one of the first pins of each first side plate forms an elastic raised portion on the circumference of the one of the first pins, for engagement in the positioning slot to position the first side plate substantially perpendicular to the bottom plate.

13. The electronic device of claim 10, wherein a second pivot hole is defined in each second connecting portion, each second side plate comprises two projections extending from opposite ends of the second side plate, two second pins extend from the ends of the second side plate below the corresponding projections, the second pins are pivotably engaged in the corresponding second pivot holes.

14. The electronic device of claim 13, wherein a positioning slot is defined in an inner surface bounding one of the second pivot holes of each end of the bottom plate, one of the second pins of each second side plate forms an elastic raised portion on the circumference of the one of the second pins, for engagement in the positioning slot to position the second side plate substantially perpendicular to the bottom plate.

15. The electronic device of claim 8, wherein two mounting holes are defined in each first side plate, the dummy hard disk drive is mounted between the sidewalls through screws extending through the sidewalls to screw in the mounting holes.
